(19) United States
(12) Patent Application Publication
(10) Pub. No.: US 2024/0158706 A1
(43) Pub. Date: May 16, 2024

(54) UPGRADING OF THE AROMATICS ORIGINATING FROM CATALYTIC CRACKED GASOLINES TO THE AROMATICS COMPLEX

(71) Applicant: IFP ENERGIES NOUVELLES, RUEIL-MALMAISON (FR)

(72) Inventors: Jérémy GAZARIAN, RUEIL-MALMAISON CEDEX (FR); Sophie COUDERC, RUEIL-MALMAISON CEDEX (FR); Pierre-Alain BREUIL, RUEIL-MALMAISON CEDEX (FR); Réjane DASTILLUNG, RUEIL-MALMAISON CEDEX (FR); Annick PUCCI, RUEIL-MALMAISON (FR); Souhir MATHIEU, RUEIL-MALMAISON (FR); Anaïs DORSEY, RUEIL-MALMAISON (FR)

(73) Assignee: IFP ENERGIES NOUVELLES, RUEIL-MALMAISON (FR)

(21) Appl. No.: 18/284,446

(22) PCT Filed: Mar. 23, 2022
(86) PCT No.: PCT/EP2022/057567

§ 371 Date: Sep. 27, 2023

(30) Foreign Application Priority Data
Mar. 30, 2021 (FR) FR2103284

(51) Int. Cl. C10G 67/04; B01D 3/14; B01D 11/04; B01J 8/18; B01J 8/26

(52) U.S. Cl. CPC C10G 67/0427; B01D 3/143; B01D 11/0488; B01D 11/0492; B01J 8/1827; B01J 8/26; C10G 2300/1044; C10G 2400/02; C10G 2400/30

(57) ABSTRACT

The present invention relates to a process and a device for the treatment and separation of aromatic compounds starting from a gasoline feedstock, comprising the following stages/units: selective hydrogenation (A) of the gasoline feedstock (1) in the presence of hydrogen (2) in order to produce a selective hydrogenation effluent (3); fractionation (B) of the selective hydrogenation effluent (3) in order to produce at least a C5− cut (4) containing compounds having 5 or less carbon atoms and a C6+ cut (5) containing compounds having at least 6 carbon atoms; hydrogenation (C) of the C6+ cut (5) in order to produce a hydrogenation effluent (6); extraction of the aromatics (D) from the hydrogenation effluent (6) in order to produce at least an aromatic stream (17) concentrated in aromatic compounds and a raffinate (10) concentrated in non-aromatic compounds, with respect to the composition of the hydrogenation effluent (6).

### TECHNICAL FIELD

The field of the invention relates to the treatment and separation of aromatic compounds, such as benzene, toluene, xylenes (BTX), but also aromatic compounds having 9 or 10 carbon atoms (A9, A10), for the petrochemical industry originating from a gasoline feedstock, such as gasoline cuts resulting from catalytic cracking technologies.

### PRIOR ART

Patent FR 2 925 065 B1 claims a scheme making it possible to produce a high-octane-number gasoline base with, as co-product, aromatics upstream of an aromatics complex. This sequence provides a unit for the separation of aromatics starting from one or more naphtha cuts, producing a raffinate containing most of the non-aromatic compounds which is sent, at least in part, to a catalytic reforming unit producing a high-octane-number gasoline cut with recycling of this gasoline to the aromatic separation unit or to an “aromatics complex” unit. The extract originating from the aromatics separation unit, containing most of the aromatics, is sent, in all or in part, to the aromatics complex.

### SUMMARY OF THE INVENTION

In the context described above, a first object of the present description is to provide an improved treatment and separation process for the production of aromatics which are compatible with injection into an aromatics complex.

Surprisingly, the Applicant Company has identified that the treatment of a gasoline feedstock, such as a catalytic cracking (e.g., FCC for Fluid Catalytic Cracking) gasoline, by a series of selective hydrogenation, of fractionation, of hydrogenation and of extraction stages, made possible an improved separation of aromatic compounds ranging from 6 to 11 carbon atoms.

According to a first aspect, the abovementioned objects, and also other advantages, are obtained by a process for the treatment and separation of aromatic compounds from a gasoline feedstock, comprising the following stages:
selective hydrogenation of the gasoline feedstock in order to hydrogenate at least diolefins contained in the gasoline feedstock in the presence of hydrogen and to produce a selective hydrogenation effluent;
fractionation of the selective hydrogenation effluent in order to produce at least a C5− cut containing compounds having 5 or less carbon atoms and a C6+ cut containing compounds having at least 6 carbon atoms;
hydrogenation of the C6+ cut in order to hydrogenate at least olefins contained in the C6+ cut in the presence of hydrogen and to produce a hydrogenation effluent;
extraction of the aromatics from the hydrogenation effluent in order to produce at least an aromatic stream concentrated in aromatic compounds with respect to the hydrogenation effluent and a raffinate concentrated in non-aromatic compounds with respect to the composition of the hydrogenation effluent.

According to one or more embodiments, the gasoline feedstock comprises a gasoline cut resulting from a catalytic cracking unit.

According to one or more embodiments, the selective hydrogenation stage is carried out at at least one of the following operating conditions: presence of at least one catalyst comprising a support and an active phase comprising at least one element from Group VIII, temperature of between 50 and 250° C., liquid hourly space velocity LHSV of between 0.5 h⁻¹ and 20 h⁻¹, pressure of between 0.4 and 5 MPa, H₂/gasoline feedstock ratio by volume of between 2 and 100 Sm³/m³.

According to one or more embodiments, the fractionation stage is controlled in order to produce a C6+ cut exhibiting a content of less than or equal to 5000 ppm by weight of compounds having a boiling point of greater than 217° C.

According to one or more embodiments, the hydrogenation stage is carried out at at least one of the following operating conditions: presence of at least one catalyst comprising a support and an active phase comprising at least one element from Group VIII, temperature of between 100 and 400° C., liquid hourly space velocity LHSV of between 0.1 h⁻¹ and 20 h⁻¹, pressure of between 0.1 and 5 MPaa (MPa abs), H₂/gasoline feedstock ratio by volume of between 1 and 400 Sm³/m³.

According to one or more embodiments, the stage of extraction of the aromatics comprises the following stages:
extraction of the aromatics from the hydrogenation effluent by means of a liquid-liquid extractor fed with a solvent stream in order to separate the raffinate and an extract concentrated in aromatics with respect to the composition of the hydrogenation effluent;
stripping of the extract by means of an extract stripping section in order to separate a gas stream comprising non-aromatic compounds and a purified extract;
separation of the aromatics from the purified extract and the solvent by means of an aromatic recovery tower in order to separate the solvent stream and the top vapours comprising the aromatic stream.

According to one or more embodiments, the stage of extraction of the aromatics additionally comprises at least one of the following stages:
feeding the liquid-liquid extractor with a solvent stream comprising a solvent chosen from ethylene glycol, diethylene glycol, triethylene glycol, hexamethylphosphoramide, propylene carbonate, ethylene carbonate, sulfolane, 3-methylsulfolane, N-methylacetamide, N,N-dimethylacetamide, butyrolactone, 1-methylpyrrolidone, dimethyl sulfoxide, caprolactam, N-methylformamide, pyrrolidin-2-one, furfural, 1,1,3,3-tetramethylurea and a mixture of these;
phase separation of the gas stream in a condenser-settler in order to separate a raffinate recycle stream and an aqueous phase;
scrubbing the raffinate with water by means of a water scrubbing tower fed with water in order to produce a non-aromatic stream and aqueous scrubbing liquor;
regeneration of at least a portion of the solvent stream by means of a section for regeneration of the solvent by vacuum steam stripping;
condensation of the top vapours in a condenser-settler in order to produce the aromatic stream.

According to one or more embodiments, the solvent stream comprises or consists essentially of sulfolane.

According to one or more embodiments, the stage of extraction of the aromatics additionally comprises at least one of the following stages:
feeding the liquid-liquid extractor with a stream of solvent chosen from ethylene glycol, diethylene glycol, triethylene glycol, hexamethylphosphoramide, propylene carbonate, ethylene carbonate, sulfolane, 3-methylsulfolane, N-methylacetamide, N,N-dimethylacetamide, butyrolactone, 1-methylpyrrolidone, dimethyl sulfoxide, caprolactam, N-methylformamide, pyrrolidin-2-one, furfural, 1,1,3,3-tetramethylurea and a mixture of these;
recycling the raffinate recycle stream to the liquid-liquid extractor;
stripping the hydrocarbon compounds present in the aqueous scrubbing liquor and/or in the aqueous phase by means of a water stripping section in order to produce water;
feeding the aromatic recovery tower with steam in order to produce top vapours additionally comprising steam, and condensation of the top vapours in the condenser-settler in order to produce the aromatic stream and water separated by settling.

According to one or more embodiments, the stage of extraction of the aromatics additionally comprises at least one of the following stages:
feeding the liquid-liquid extractor with a stream of solvent chosen from ethylene glycol, diethylene glycol, triethylene glycol, hexamethylphosphoramide, propylene carbonate, ethylene carbonate, sulfolane, 3-methylsulfolane, N-methylacetamide, N,N-dimethylacetamide, butyrolactone, 1-methylpyrrolidone, dimethyl sulfoxide, caprolactam, N-methylformamide, pyrrolidin-2-one, furfural, 1,1,3,3-tetramethylurea and a mixture of these and which comprises water;
recycling the water produced by the water stripping section to the aromatic recovery tower.

According to one or more embodiments, at least one pyrolysis gasoline is sent into the fractionation unit B and/or into the hydrogenation unit C.

According to a second aspect, the abovementioned objects, and also other advantages, are obtained by a device for the treatment and separation of aromatic compounds from a gasoline feedstock, comprising the following units:
a selective hydrogenation unit for hydrogenating at least diolefins contained in the gasoline feedstock in the presence of hydrogen and for producing a selective hydrogenation effluent;
a fractionation unit for fractionating the selective hydrogenation effluent and producing at least a C5− cut containing compounds having 5 or less carbon atoms and a C6+ cut containing compounds having at least 6 carbon atoms;
a hydrogenation unit for hydrogenating at least olefins contained in the C6+ cut in the presence of hydrogen and producing a hydrogenation effluent;
an aromatic extraction unit for extracting aromatics from the hydrogenation effluent and producing at least an aromatic stream concentrated in aromatic compounds with respect to the hydrogenation effluent and a raffinate concentrated in non-aromatic compounds with respect to the composition of the hydrogenation effluent.

According to one or more embodiments, the aromatic extraction unit comprises the following elements:
a liquid-liquid extractor suitable for being fed with a solvent stream and the hydrogenation effluent and suitable for separating the raffinate and an extract concentrated in aromatics with respect to the composition of the hydrogenation effluent;
an extract stripping section suitable for being fed with the extract and suitable for separating a gas stream comprising non-aromatic compounds and a purified extract; and
a recovery tower suitable for being fed with the purified extract and suitable for separating aromatics from the purified extract in order to produce the solvent stream and top vapours comprising the aromatic stream.

According to one or more embodiments, the aromatic extraction unit additionally comprises at least one of the following elements:
a liquid-liquid extractor suitable for being fed with a solvent stream comprising a solvent chosen from ethylene glycol, diethylene glycol, triethylene glycol, hexamethylphosphoramide, propylene carbonate, ethylene carbonate, sulfolane, 3-methylsulfolane, N-methylacetamide, N,N-dimethylacetamide, butyrolactone, 1-methylpyrrolidone, dimethyl sulfoxide, caprolactam, N-methylformamide, pyrrolidin-2-one, furfural, 1,1,3,3-tetramethylurea and a mixture of these;
a condenser-settler suitable for being fed with the gas stream and suitable for separating the gas stream and producing a raffinate recycle stream and an aqueous phase;
a water scrubbing tower suitable for being fed with water and the raffinate and suitable for scrubbing the raffinate with water and producing a non-aromatic stream and aqueous scrubbing liquor;
a solvent regeneration section suitable for being fed with at least a portion of the solvent stream and suitable for regenerating the portion of the solvent stream by vacuum steam stripping;
a condenser-settler suitable for being fed with the top vapours and suitable for condensing the top vapours and producing the aromatic stream.

According to one or more embodiments, the aromatic extraction unit additionally comprises at least one of the following elements:
a liquid-liquid extractor suitable for being fed with a stream of solvent chosen from ethylene glycol, diethylene glycol, triethylene glycol, hexamethylphosphoramide, propylene carbonate, ethylene carbonate, sulfolane, 3-methylsulfolane, N-methylacetamide, N,N-dimethylacetamide, butyrolactone, 1-methylpyrrolidone, dimethyl sulfoxide, caprolactam, N-methylformamide, pyrrolidin-2-one, furfural, 1,1,3,3-tetramethylurea and a mixture of these;
a liquid-liquid extractor suitable for being fed with the raffinate recycle stream;
a water stripping section suitable for being fed with the aqueous scrubbing liquor and/or the aqueous phase and suitable for stripping the hydrocarbon compounds from the aqueous scrubbing liquor and/or from the aqueous phase in order to produce water;
an aromatic recovery tower suitable for being fed with steam and suitable for producing top vapours additionally comprising steam, and a condenser-settler suitable for condensing the top vapours in order to produce the aromatic stream and water separated by settling.

According to one or more embodiments, the aromatic extraction unit additionally comprises at least one of the following elements:
a liquid-liquid extractor suitable for being fed with a solvent stream comprising sulfolane and water;
an aromatic recovery tower suitable for being fed with the water produced by the water stripping section.

Embodiments according to the abovementioned aspects and also other characteristics and advantages will become apparent on reading the description which will follow, given solely by way of illustration and without limitation, and with reference to the following drawings.

### LIST OF THE FIGURES

FIG. 1 diagrammatically shows a treatment and separation process according to the present invention.

FIG. 2 diagrammatically shows a treatment and separation process according to FIG. 1 additionally comprising a second fractionation column.

FIG. 3 diagrammatically shows the stage of and the unit for extraction of the aromatics of the process and of the device according to FIG. 1 and FIG. 2.

### DESCRIPTION OF THE EMBODIMENTS

Embodiments of the invention will now be described in detail. In the following detailed description, numerous specific details are disclosed in order to provide a deeper understanding of the invention. However, it will be apparent to a person skilled in the art that the invention can be performed without these specific details. In other cases, well-known characteristics have not been described in detail in order to avoid unnecessarily complicating the description.

In the present patent application, the term “to comprise” is synonymous with (means the same thing as) “to include” and “to contain”, and is inclusive or open and does not exclude other elements which are not stated. It is understood that the term “to comprise” includes the exclusive and closed term “to consist”. The term “based on” is synonymous with “comprises at least 50% by weight of”. Moreover, in the present description, the terms “essentially” or “substantially” correspond to an approximation of ±5%, preferably of ±1%, very preferably of ±0.5%. For example, an effluent comprising essentially or consisting of compounds A corresponds to an effluent comprising at least 95% by weight of compounds A.

The present invention relates to the separation of aromatic compounds, and in particular of BTX compounds, but also aromatic compounds having 9 or 10, indeed even 11, carbon atoms (A9, A11), for the petrochemical industry originating from a gasoline feedstock, such as a catalytic cracking gasoline. It relates in particular to an improved process and device for the separation of aromatic compounds involving a sequence of selective hydrogenation, of fractionation, of hydrogenation and of extraction stages and units making it possible to improve the separation of aromatic compounds with from 6 to 11 carbon atoms.

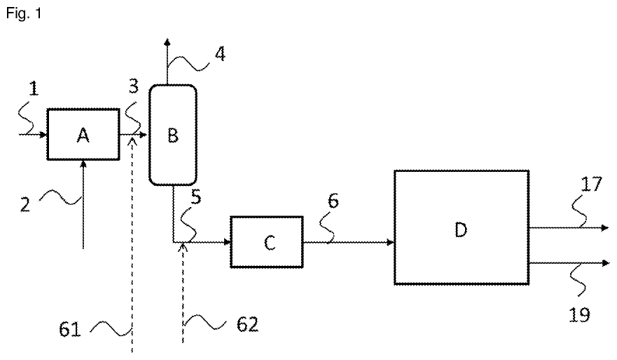

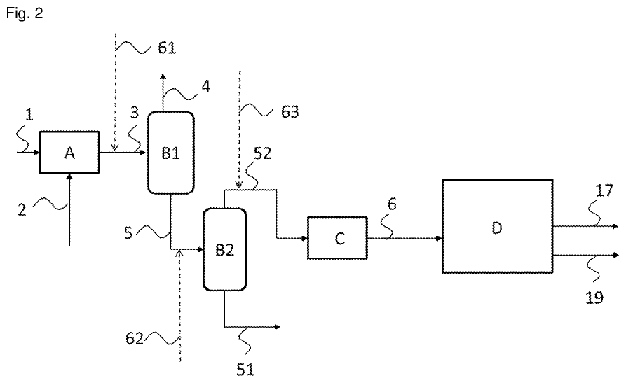

Specifically, with reference to FIG. 1 and FIG. 2, the process and the device according to the present invention involve a selective hydrogenation stage/unit A making it possible to selectively hydrogenate a gasoline feedstock 1 in the presence of hydrogen 2, and thus to hydrogenate (essentially all) diolefins contained in the feedstock and optionally to convert a part of the light sulfur compounds to heavier sulfur compounds. The process and the device according to the present invention also involve a stage of/unit for fractionation B of the selective hydrogenation effluent 3 (by means of a first fractionation column B1) making it possible to obtain at least a gasoline cut containing compounds having 5 or less carbon atoms, a cut referred to as C5− cut 4, and a gasoline cut containing compounds having at least 6 carbon atoms, a cut referred to as (first) C6+ cut 5, the C6+ cut 5 being sent to the hydrogenation stage/unit C. With reference to FIG. 2, the hydrogenation stage/unit C can be preceded by a stage of additional fractionation (by means of a second fractionation column B2) in order to limit the presence of certain compounds regarded as contaminants for the aromatic bases in the C6+ cut 5 and thus to separate a heavy gasoline cut 51. The second C6+ cut 52 at the outlet of the additional fractionation stage is subsequently sent to a hydrogenation stage/unit C. In the hydrogenation unit C, the olefinic compounds and the alkenylaromatic compounds are hydrogenated while the sulfur, nitrogen and oxygen compounds are (essentially completely) hydrotreated. The hydrogenation effluent 6 is sent to a stage of/unit for extraction of the aromatics D making it possible to produce a stream concentrated (i.e., enriched) in aromatic compounds (aromatic stream 17) and a stream concentrated in non-aromatic compounds (raffinate 10, optionally scrubbed). The aromatic separation process/device as envisaged makes it possible to obtain an improved yield for recovery of the aromatics while guaranteeing a high purity, in particular benzene purity. The non-aromatic stream 19 can be sent to a thermal cracking stage/unit or else to a catalytic reforming stage/unit, for example in order to increase the production of aromatics.

### The Feedstock

The process according to the invention makes it possible to treat a gasoline feedstock. According to one or more embodiments, the gasoline feedstock 1 comprises a gasoline cut resulting from a catalytic cracking unit. According to one or more embodiments, the gasoline feedstock 1 consists of at least 50% by weight or 60% by weight, preferably at least 70% by weight or 80% by weight, very preferably at least 90% by weight or 95% by weight, such as at least 97% by weight or 99% by weight, of a gasoline cut resulting from a catalytic cracking unit, with respect to the total weight of the feedstock. According to one or more embodiments, the gasoline feedstock 1 consists (solely) of a gasoline cut resulting from a catalytic cracking unit. According to one or more embodiments, the gasoline cut results from a unit selected from the list consisting of a fluidized bed catalytic cracking (FCC—Fluid Catalytic Cracking) unit.

According to one or more embodiments, the gasoline feedstock 1 comprises compounds, the range of boiling points of which extends from the boiling points of hydrocarbons having 2 or 3 carbon atoms (C2 or C3) up to 260° C., preferably up to 240° C. or 220° C. According to one or more embodiments, the gasoline feedstock 1 comprises compounds, the range of boiling points of which extends from the boiling points of hydrocarbons having 4 or 5 carbon atoms (C4 or C5) up to 260° C., preferably up to 240° C. or 220° C. According to one or more embodiments, the feedstock comprises compounds, the range of boiling points of which extends from the boiling points of hydrocarbons having 5 carbon atoms (C5) up to 260° C., preferably up to 240° C., very preferably up to 220° C. In the present patent application, boiling point of a compound is understood to mean, when not specified, the boiling point of a compound at atmospheric pressure.

The feedstock comprises saturated hydrocarbon compounds and unsaturated hydrocarbon compounds. According to one or more embodiments, the feedstock is rich (e.g., at least 40% by weight) in unsaturated hydrocarbon compounds (e.g., monoolefins, diolefins, aromatics).

According to one or more embodiments, the feedstock comprises at least 50% by weight of unsaturated hydrocarbon compounds, preferably at least 60% by weight of unsaturated hydrocarbon compounds, very preferably at least 70% by weight of unsaturated hydrocarbon compounds, with respect to the total weight of the feedstock. According to one or more embodiments, the feedstock comprises at least 10% by weight of olefins, preferably at least 20% by weight of olefins, very preferably at least 30% by weight of olefins (e.g., at least 40% by weight), with respect to the total weight of the feedstock. According to one or more embodiments, the feedstock comprises at least 10% by weight of monoolefins, preferably at least 20% by weight of monoolefins, very preferably at least 30% by weight of monoolefins (e.g., at least 40% by weight), with respect to the total weight of the feedstock. According to one or more embodiments, the feedstock comprises less than 10% by weight of diolefins. According to one or more embodiments, the feedstock comprises between 0.1% or 0.5% by weight and 5% by weight of diolefins, with respect to the total weight of the feedstock. According to one or more embodiments, the feedstock comprises at least 10% by weight of aromatic compounds, preferably at least 20% by weight of aromatic compounds, very preferably at least 30% by weight of aromatic compounds (e.g., at least 40% by weight), with respect to the total weight of the feedstock.

The feedstock can additionally comprise sulfur compounds. According to one or more embodiments, the feedstock comprises between 0 ppm by weight and 5000 ppm by weight (i.e., 0.5% by weight) of sulfur, with respect to the total weight of the feedstock. According to one or more embodiments, the feedstock comprises between 10 ppm by weight and 2000 ppm by weight of sulfur. The sulfur content in the feedstock is generally greater than 50 ppm by weight. The sulfur content depends generally on the sulfur content of the feedstock treated by the FCC, on the presence or not of a pretreatment of the feedstock of the FCC, and also on the end boiling point of the cut.

According to one or more embodiments, the feedstock treated by the process contains between 0.5% and 5% by weight of diolefins, between 20% and 50% by weight of olefins, between 20% and 40% of aromatics and between 10 ppm by weight and 0.5% by weight of sulfur, with respect to the total weight of the feedstock.

### Selective Hydrogenation

The gasoline feedstock 1 is treated in a selective hydrogenation unit A in the presence of hydrogen 2 so as to at least partially hydrogenated the diolefins. According to one or more embodiments, the gasoline feedstock is also treated so as to carry out a reaction for increasing the molecular weight of at least a part of the light mercaptan compounds (RSH) potentially present in the feedstock to give thioethers by reaction with olefins.

According to one or more embodiments, the gasoline to be treated is sent to a selective hydrogenation catalytic reactor containing at least one fixed or moving bed of catalyst for the selective hydrogenation of the diolefins and optionally for increasing the molecular weight of the light mercaptans.

According to one or more embodiments, the reaction for the selective hydrogenation of the diolefins and optionally for increasing the molecular weight of the light mercaptans is carried out over at least one catalyst comprising a support and an active phase comprising at least one element from Group VIII and optionally at least one element from Group VIb. The element from Group VIII is preferably chosen from nickel and cobalt and in particular nickel. The element from Group VIb, when it is present, is preferably chosen from molybdenum and tungsten and very preferably molybdenum. The support of the selective hydrogenation catalyst is preferably an oxide support. The oxide support is preferably chosen from alumina, nickel aluminate, silica, silicon carbide or a mixture of these oxides. Use is preferably made of alumina, such as γ-alumina, and more preferably still of high-purity alumina (e.g., purity at at least 99.8% by weight). According to one or more embodiments, the hydrogenation catalyst comprises an alumina-based support. According to one or more embodiments, the support comprises at least 50% of alumina. According to one or more embodiments, the support consists of alumina.

According to one or more embodiments, the selective hydrogenation catalyst contains at least one element from Group VIII (e.g. nickel) at a content by weight of metal oxide of between 0.5% and 20%, preferably between 1% and 12% by weight, with respect to the total weight of the catalyst. According to one or more embodiments, the selective hydrogenation catalyst contains at least one element from Group VIb (e.g. molybdenum) at a content by weight of metal oxide of between 3% and 30%, preferably between 6% and 18%, by weight, with respect to the total weight of the catalyst. According to one or more embodiments, the selective hydrogenation catalyst exhibits an element from Group VIII/element from Group VIb (e.g. Ni/Mo) molar ratio of between 0.2 and 4, preferably between 0.3 and 2.5. According to one or more embodiments, the catalyst is sulfided. The degree of sulfidation of the metals constituting the catalyst is, in a preferred way, greater than 60% and preferably greater than 80%.

According to one or more embodiments, the selective hydrogenation catalyst contains nickel at a content by weight of nickel oxide, in NiO form, of between 1% and 12% by weight, with respect to the total weight of the catalyst, and molybdenum at a content by weight of molybdenum oxide, in MoO₃ form, of between 6% and 18% by weight, with respect to the total weight of the catalyst, and a nickel/molybdenum molar ratio of between 0.3 and 2.5, the metals being deposited on a support consisting of alumina.

The groups of chemical elements are given according to the CAS classification (CRC Handbook of Chemistry and Physics, published by CRC Press, Editor in Chief D. R. Lide, 81st edition, 2000-2001). For example, Group VIII according to the CAS classification corresponds to the metals from Columns 8, 9 and 10 according to the new IUPAC classification; Group VIb according to the CAS classification corresponds to the metals from Column 6 according to the new IUPAC classification. The contents of metals from Group VIII and from Group VIb can be measured by X-ray fluorescence. The contents of metal from Group VIb and of metal from Group VIII in the catalysts are expressed as oxides, for example after correction for the loss on ignition of the catalyst sample at 550° C. in a muffle furnace for two hours. The loss on ignition is due to the loss of moisture and can be determined according to ASTM D7348. When the metal is cobalt or nickel, the metal content is expressed as CoO and NiO, respectively. When the metal is molybdenum or tungsten, the metal content is expressed as MoO₃ and WO₃ respectively.

According to one or more embodiments, during the selective hydrogenation stage, the gasoline is brought into contact with the catalyst in the presence of hydrogen 2 at a temperature of between 50 and 250° C., preferably between 80 and 220° C. and more preferably still between 90 and 200° C. According to one or more embodiments, the liquid hourly space velocity LHSV is between 0.5 h⁻¹ and 20 h⁻¹, preferably between 1 h⁻¹ and 10 h⁻¹ and more preferably still between 2 h⁻¹ and 6 h⁻¹, the unit of the liquid hourly space velocity being the m³ of feedstock per m³ of catalyst and per hour (m³/m³/h). According to one or more embodiments, the pressure is between 0.4 and 5 MPa, preferably between 0.6 and 4 MPa and more preferably still between 1 and 3 MPa. According to one or more embodiments, the selective hydrogenation stage is carried out with an H₂/feedstock ratio by volume of the hydrogen 2 flow rate, expressed in standard m³ per hour, to the flow rate of feedstock to be treated, expressed in m³ per hour at standard conditions, of between 2 and 100 Sm³/m³, preferably between 3 and 30 Sm³/m³.

Advantageously, the selective hydrogenation effluent 3 obtained at the outlet of the selective hydrogenation unit A comprises less than 1% by weight, preferably less than 0.5% by weight, very preferably less than 0.1% by weight, of diolefins, with respect to the total weight of the selective hydrogenation effluent 3.

The selective hydrogenation effluent 3 is sent, at least in part, to a fractionation unit B.

### Fractionation

The fractionation of the effluent from the first selective hydrogenation stage makes it possible to obtain at least two cuts: a gasoline cut containing compounds having 5 or less carbon atoms, a cut referred to as C5− cut 4 or desulfurized light gasoline cut; a gasoline cut containing compounds having at least 6 carbon atoms, a cut referred to as (first) C6+ cut 5 or gasoline cut rich in aromatics; and optionally a heavy gasoline cut as defined below.

According to one or more embodiments, the C5− cut 4 is a desulfurized (e.g. having a sulfur content of less than or equal to 10 ppm by weight) gasoline cut and comprises a large part (e.g. at least 80% by weight, preferably 90% by weight, very preferably at least 95% by weight) of the mono-olefins (C2-C5 olefins) in the gasoline feedstock 1.

According to one or more embodiments, the C5− cut 4 is withdrawn at the top of a first fractionation column B1 and is exited from the process. For example, the C5− cut 4 can be sent to a gasoline pool. According to one or more embodiments, the cut point of the C5− cut 4 is made at a temperature of less than 100° C., preferably at a temperature of between 40° C. and 100° C. According to one or more embodiments, the cut point of the C5− cut 4 is between 45° C. and 80° C.

The end boiling point of the C5− cut 4 is preferably chosen so as to provide a C5− cut 4 having a very low sulfur content (sulfur content preferably of less than 10 ppm by weight). Advantageously, the desulfurized C5− cut 4 does not require a subsequent hydrodesulfurization stage. According to one or more embodiments, the C5− cut 4 comprises a sulfur content of less than 100 ppm by weight, preferably of less than 50 ppm by weight, very preferably of less than 10 ppm by weight.

The end boiling point of the C5− cut 4 is preferably chosen so as to promote the recovery of the benzene in the C6+ cut 5. According to one or more embodiments, the C5− cut 4 comprises less than 10% by weight, preferably less than 5% by weight and very preferably less than 1% by weight of benzene, with respect to the total weight of the C5− cut 4.

According to one or more embodiments, the C6+ cut 5 comprises/consists substantially of aromatic compounds ranging from 6 to 11 carbon atoms. According to one or more embodiments, the C6+ cut 5 comprises/consists substantially of aromatic compounds ranging from 6 to 10 carbon atoms. According to one or more embodiments, the C6+ cut is a gasoline cut rich in aromatics, preferably while limiting the content of naphthalene and heavy compounds (e.g., aromatic compounds having 11 or more carbon atoms and/or compounds, the boiling point of which is greater than 217° C.) to less than or equal to 5000 ppm by weight, preferably less than or equal to 4500 ppm by weight and very preferably less than or equal to 3000 ppm by weight.

According to one or more embodiments, the C6+ cut 5 is withdrawn at the bottom of the first fractionation column B1. According to one or more embodiments, the cut point of the C6+ cut 5 is made at a temperature of greater than 40° C., preferably at a temperature of between 45° C. and 100° C. According to one or more embodiments, the cut point of the C6+ cut 5 is between 45° C. and 80° C.

According to one or more embodiments, the C6+ cut 5 exhibits a content of less than or equal to 5000 ppm by weight, preferably of less than or equal to 4500 ppm by weight and very preferably of less than or equal to 3000 ppm by weight, of compounds comprising the compounds having a boiling point of greater than 217° C., including naphthalene, and/or the aromatic compounds having at least 11 carbon atoms.

According to one or more embodiments, when the C6+ cut 5 exhibits a content of greater than 5000 ppm by weight or 4500 ppm by weight of compounds having a boiling point of greater than 217° C., and/or of naphthalene, and/or of aromatic compounds having 11 or more carbon atoms, a second fractionation column B2 can be employed in order to separate the C6+ cut 5 into 2 cuts: a second C6+ cut 52 at the column top, exhibiting a content of less than or equal to 5000 ppm by weight, preferably of less than or equal to 4500 ppm by weight and very preferably of less than or equal to 3000 ppm by weight, of compounds comprising the compounds having a boiling point of greater than 217° C., including naphthalene, and/or the aromatic compounds having at least 6 carbon atoms; and a heavy gasoline cut 51 (cut referred to as C11+) at the column bottom, exhibiting a content of greater than or equal to 3000 ppm by weight or 4500 ppm by weight of compounds having a boiling point of greater than 217° C., and/or of naphthalene, and/or of aromatic compounds having 11 or more carbon atoms. According to one or more embodiments, the second C6+ cut 52 comprises essentially compounds comprising from 6 to 9 or 10 carbon atoms. According to one or more embodiments, the heavy gasoline cut 51 comprises essentially compounds comprising at least 10 or 11 carbon atoms.

According to one or more embodiments, the heavy gasoline cut 51 is directed to a hydrodesulfurization stage and optionally a stage of stabilization of the hydrodesulfurized effluent (stages not described) in order to produce a gasoline (e.g., sulfur content of less than 50 ppm by weight, preferably of less than 10 ppm by weight).

According to one or more embodiments, the operating conditions of the second fractionation column B2 are adjusted so as to obtain a second C6+ cut 52, the temperature difference (ΔT) of which between the temperatures corresponding to 5% and to 95% of the distilled weight is between 130° C. and 180° C., preferably is between 140° C. and 160° C. According to one or more embodiments, the temperature corresponding to 5% of the distilled weight of the second C6+ cut 52 is between 30° C. and 80° C., preferably between 50° C. and 65° C., and the temperature corresponding to 95% of the distilled weight of the gasoline cut rich in aromatics is between 180° C. and 220° C., preferably between 190° C. and 210° C. The method used to determine the temperatures corresponding to 5% and 95% of the distilled weight is described in the document Oil Gas Sci. Technol., Vol. 54 (1999), No. 4, pp. 431-438, under the name “CSD method” (CSD abbreviation for Conventional Simulated Distillation).

Advantageously, the first or the second C6+ cut (5 or 52) resulting from the fractionation unit B comprises at least 20% by weight, preferably at least 30% by weight, very preferably at least 40% by weight (e.g., at least 50% by weight), of aromatic compounds, with respect to the total weight of the C6+ cut.

The first or the second C6+ cut (5 or 52) resulting from the fractionation unit B is sent, at least in part, to the hydrogenation unit C.

### Hydrogenation

In the hydrogenation unit C, the C6+ cut 5 or 52 originating from the fractionation stage is treated in the presence of hydrogen in a hydrogenation unit C so as to hydrogenate the olefinic compounds and the alkenylaromatic compounds and to (completely) hydrotreat (preferably essentially completely) the sulfur, nitrogen and oxygen compounds still present.

According to one or more embodiments, a pyrolysis gasoline 62 or 63 (PyGas) is sent into the hydrogenation unit C, for example as a mixture with the feedstock of the hydrogenation stage C, i.e. the C6+ cut 5 or 52. According to one or more embodiments, the pyrolysis gasoline 62 is sent into the second fractionation column B2 of the fractionation unit B. According to one or more embodiments, a pyrolysis gasoline 61 is sent into the fractionation unit B, for example as a mixture with the selective hydrogenation effluent 3.

According to one or more embodiments, the pyrolysis gasoline comprises or consists of a C5-C12 cut, the composition of which is as follows: 2% to 15% by weight of paraffins, 30% to 65% by weight of aromatics, 5% to 15% by weight of monoolefins, 15% to 30% by weight of diolefins, 2% to 8% by weight of alkenylaromatic compounds and from 20 to 2000 ppm by weight and preferably from 20 to 300 ppm by weight of sulfur. This is because some difficult pyrolysis gasolines can exhibit up to 2000 ppm by weight for some difficult feedstocks, such as sulfur.

According to one or more embodiments, the pyrolysis gasoline is hydrotreated at least partially, for example originating from a first hydrotreating stage referred to as HD1. In the case of the upgrading of pyrolysis gasolines as source of cut rich in aromatic hydrocarbon, one treatment which can be envisaged is composed of two stages. A first stage (also referred to as HD1) targeted at the selective hydrogenation of the highly unsaturated compounds (diolefins and alkenylaromatics) and a second stage of hydrotreating (also referred to as HD2) the sulfur compounds and of hydrogenation (preferably complete) of the olefins. In the case of the upgrading of pyrolysis gasolines as source of cut rich in aromatic hydrocarbon, it is standard practice to carry out (e.g. at the outlet of the HD1 stage) a separation of the C5− compounds for the gasoline pool and to send the C6+ cut to the HD2 stage.

According to one or more embodiments, the pyrolysis gasoline hydrotreated at least partially, for example originating from a first hydrotreating stage referred to as HD1, has the following properties: C6-C8 cut, the composition of which is as follows: 3% to 21% by weight of paraffins, 44% to 91% by weight of aromatics, 7% to 21% by weight of monoolefins and from 20 to 300 ppm by weight of sulfur, indeed even up to 2000 ppm by weight for some difficult feedstocks.

According to one or more embodiments, the hydrogenation stage is carried out in at least one fixed or moving bed catalytic reactor in the presence of one or more beds of hydrogenation and hydrotreating catalysts.

According to one or more embodiments, the hydrogenation stage is carried out with a first bed comprising at least one catalyst making it possible to remove the olefinic and optionally alkenylaromatic compounds. According to one or more embodiments, the catalyst comprises a support and an active phase comprising at least one element from Group VIII and optionally at least one element from Group VIb. The element from Group VIII is preferably chosen from nickel and cobalt and in particular nickel. The element from Group VIb, when it is present, is preferably chosen from molybdenum and tungsten and very preferably molybdenum. The support of the hydrogenation catalyst is preferably an oxide support. The oxide support is preferably chosen from alumina, nickel aluminate, silica, silicon carbide or a mixture of these oxides. Use is preferably made of alumina, such as γ-alumina, and more preferably still of high-purity alumina (e.g., purity at at least 99.8% by weight). According to one or more embodiments, the hydrogenation catalyst comprises a support based on alumina and preferably consisting of alumina.

According to one or more embodiments, the hydrotreating catalyst contains at least one element from Group VIII (e.g. nickel) at a content by weight of metal oxide of between 0.5% and 20%, preferably between 1% and 13% by weight, with respect to the total weight of the catalyst. According to one or more embodiments, the hydrogenation catalyst contains at least one element from Group VIb (e.g. molybdenum) at a content by weight of metal oxide of between 3% and 30%, preferably between 6% and 18%, by weight, with respect to the total weight of the catalyst. According to one or more embodiments, the hydrogenation catalyst exhibits an element from Group VIII/element from Group VIb (e.g. Ni/Mo) molar ratio of between 0.2 and 4, preferably between 0.3 and 2.5.

According to one or more embodiments, the catalyst is sulfided. The degree of sulfidation of the metals constituting the catalyst is, in a preferred way, greater than 60% and preferably greater than 80%.

According to one or more embodiments, the hydrogenation catalyst contains nickel at a content by weight of nickel oxide, in NiO form, of between 1% and 13% by weight, with respect to the total weight of the catalyst, and molybdenum at a content by weight of molybdenum oxide, in MoO₃ form, of between 6% and 18% by weight, with respect to the total weight of the catalyst, and a nickel/molybdenum molar ratio of between 0.3 and 2.5, the metals being deposited on a support consisting of alumina.

According to one or more embodiments, the hydrogenation catalyst contains cobalt at a content by weight of cobalt oxide, in CoO form, of between 1% and 13% by weight, with respect to the total weight of the catalyst, and molybdenum at a content by weight of molybdenum oxide, in MoO₃ form, of between 6% and 18% by weight, with respect to the total weight of the catalyst, and a cobalt/molybdenum molar ratio of between 0.3 and 2.5, the metals being deposited on a support consisting of alumina.

According to one or more embodiments, during the hydrogenation stage, the gasoline is brought into contact with the catalyst in the presence of hydrogen at a temperature of between 100 and 400° C., preferably between 200 and 380° C. According to one or more embodiments, the liquid hourly space velocity (LHSV) is between 0.1 h⁻¹ and 20 h⁻¹. According to one or more embodiments, the pressure is between 0.1 and 5 MPaa, preferably between 0.5 and 4 MPaa and more preferably still between 1 and 3.5 MPaa. According to one or more embodiments, the hydrogenation stage is carried out with an H₂/feedstock ratio by volume of the hydrogen flow rate, expressed in standard m³ per hour, to the flow rate of feedstock to be treated, expressed in m³ per hour at standard conditions, of between 1 and 400 Sm³/m³ or between 1 and 300 Sm³/m³.

According to one or more embodiments, the hydrogenation unit C additionally comprises a (third) fractionation column (not represented) in order to remove at least one of the following compounds: H₂, H₂S, light gases, such as ethane, propane and butane, compounds potentially present in the effluent exiting from the catalytic hydrogenation reactor.

The hydrogenation effluent 6 obtained at the outlet of the hydrogenation unit C is directed, at least in part, to the aromatic extraction unit D.

### Extraction

The aromatic extraction unit D in the present invention makes it possible to treat the hydrogenation effluent 6 in order to recover, on the one hand, a stream concentrated in non-aromatic compounds, referred to as raffinate 10, and, on the other hand, a stream concentrated in aromatics, referred to as extract 11, with respect to the composition of the hydrogenation effluent 6.

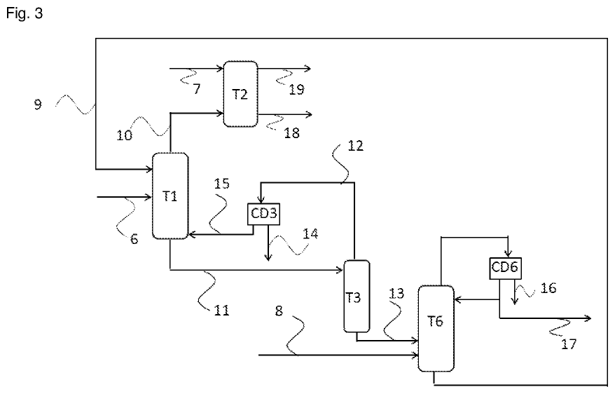

According to one or more embodiments, with reference to FIG. 3, the aromatic extraction unit D is a unit for the liquid-liquid extraction of aromatics.

According to one or more embodiments, the unit for the liquid-liquid extraction of aromatics comprises the following stages/devices:
liquid-liquid extraction by means of a liquid-liquid extractor T1 fed with solvent stream 9 in order to separate the raffinate 10 and the extract 11,
water scrubbing of the raffinate 10 with a water scrubbing tower T2 (optional stage),
stripping of the water with a water stripping section (optional stage),
stripping of the extract 11 with an extract stripping section T3,
separation of the aromatics with a recovery tower T6 in order to separate the aromatic stream 17 and the solvent stream 9, and
regeneration of the solvent with a solvent regeneration section (optional stage).

For the sake of simplicity, the optional water stripping and solvent regeneration sections are not represented in FIG. 3.

### Liquid-Liquid Extractor T1

The liquid-liquid extraction makes possible the separation of the aromatics from the non-aromatic compounds, such as paraffins and naphthenes, of the hydrogenation effluent 6.

According to one or more embodiments, the feeding with hydrogenation effluent 6 is substantially at the level of an immediate point (e.g., at the middle of the extractor).

According to one or more embodiments, an intermediate point is a point located between the bottom and the top of the liquid-liquid extractor T1. According to one or more embodiments, an intermediate point corresponds to a point preferably arranged at a position between 0.1×L and 0.9×L, more preferably between 0.2×L and 0.8×L, such as between 0.3×L and 0.7×L or between 0.4×L and 0.6×L, L being the length from the bottom to the top of the liquid-liquid extractor T1.

According to one or more embodiments, the solvent stream 9 is fed at a high point of the liquid-liquid extractor T1. According to one or more embodiments, the solvent stream 9 is fed at the top of the liquid-liquid extractor T1. In the present patent application, a high point is understood to mean a point located above the intermediate point for feeding with hydrogenation effluent 6.

According to one or more embodiments, the solvent comprises a compound chosen from ethylene glycol, diethylene glycol, triethylene glycol, hexamethylphosphoramide, propylene carbonate, ethylene carbonate, sulfolane, 3-methylsulfolane, N-methylacetamide, N,N-dimethylacetamide, butyrolactone, 1-methylpyrrolidone, dimethyl sulfoxide, caprolactam, N-methylformamide, pyrrolidin-2-one, furfural, 1,1,3,3-tetramethylurea and a mixture of these. According to one or more embodiments, the solvent comprises or consists of sulfolane. According to one or more embodiments, the solvent consists of at least 90% by weight, preferably at least 95% by weight (e.g., of at least 99% by weight), of sulfolane, with respect to the total weight of the solvent. According to one or more embodiments, the solvent additionally comprises an anti-solvent, such as water. According to one or more embodiments, the anti-solvent comprises or consists of water. According to one or more embodiments, the solvent comprises between 0.01% by weight and 5% by weight, preferably between 0.1% by weight and 3% by weight (e.g., between 0.5% by weight and 2% by weight), of anti-solvent, such as water, with respect to the total weight of the solvent.

According to one or more embodiments, the raffinate recycle stream 15, for example resulting from the extract stripping section T3, is fed at a low point of the liquid-liquid extractor T1. According to one or more embodiments, the raffinate recycle stream 15 is fed at the bottom of the liquid-liquid extractor T1. In the present patent application, a low point is understood to mean a point located below the intermediate point for feeding with hydrogenation effluent 6.

Advantageously, the liquid-liquid extractor T1 can thus be divided into two parts. The upper part (with respect to the intermediate point for feeding with hydrogenation effluent 6) makes it possible to control the yield of aromatics by liquid-liquid extraction (in particular with sulfolane). The lower part of the liquid-liquid extractor T1 makes possible a first purification of the aromatics, by virtue of the raffinate recycle stream 15. Thus, the liquid-liquid extractor T1 makes it possible to separate a raffinate 10 depleted in aromatic compounds with respect to the hydrogenation effluent 6 and an extract 11 concentrated in aromatic compounds with respect to the hydrogenation effluent 6. The raffinate 10 exits at the top of the liquid-liquid extractor T1 and is optionally sent to the water scrubbing tower T2. The extract 11 exits at the bottom of the liquid-liquid extractor T1 and is sent to the extract stripping section T3, preferably with exchange of heat with the solvent stream 9 (not represented in FIG. 3 for the sake of simplicity). According to one or more embodiments, the liquid-liquid extractor T1 operates adiabatically.

According to one or more embodiments, the solvent stream 9 to hydrogenation effluent 6 ratio by weight is between 0.1 and 50, preferably between 0.5 and 20, preferably between 1 and 9, preferably between 3 and 8, such as 5±1 or 6±1. According to one or more embodiments, the recycle stream 15 to hydrogenation effluent 6 ratio by weight is between 0.05 and 10, preferably between 0.1 and 8, preferably between 0.2 and 5, preferably between 0.3 and 2, such as 0.9±0.2.

According to one or more embodiments, the extractor is operated at a pressure of between 0.05 and 3 MPaa (0.5 and 30 bara), preferably between 0.1 and 2 MPaa (1 and 20 bara), preferably between 0.2 and 1.5 MPaa (2 and 15 bara), preferably between 0.3 and 1 MPaa (3 and 10 bara), such as at 6.5±2 MPaa, for example when the solvent comprises sulfolane. According to one or more embodiments, the extractor is operated at a temperature of between 10 and 150° C., preferably between 15 and 120° C., preferably between 20 and 100° C., preferably between 30 and 90° C., such as 54±5° C., for example when the solvent comprises sulfolane.

### Optional Water Scrubbing Tower T2

The water scrubbing of the raffinate 10 makes possible the removal of the solvent potentially present in the raffinate 10. Preferably, the raffinate 10 is cooled before entering the tower. Preferably, the raffinate 10 enters in the bottom of said tower, water 7 is introduced at the top of said tower, the non-aromatic stream 19 (scrubbed raffinate 10 thus depleted in solvent) exits at the top of said tower and the aqueous scrubbing liquor 18 (concentrated/enriched in solvent) exits in the bottom of said tower. According to one or more embodiments, the non-aromatic stream 19 comprises less than 100 ppm by weight, preferably less than 10 ppm by weight, very preferably less than 1 ppm by weight, of solvent. According to one or more embodiments, the aqueous scrubbing liquor 18 is sent to the water stripping section (not represented).

Advantageously, the non-aromatic stream 19 comprises less than 25% by weight, preferably less than 20% by weight, very preferably less than 17% by weight, of aromatic compounds, with respect to the total weight of the non-aromatic stream 19.

### Extract Stripping Section T3

The stripping of the extract 11 makes possible the removal of non-aromatic compounds still present in the extract 11. The extract 11, charged with aromatic compounds and with solvent, is preferably introduced at the top of the extract stripping section T3. In the extract stripping section T3, the purity of the extract 11 is improved as the residual non-aromatic compounds entrained with the aromatic compounds (less soluble in the solvent) are extracted in the form of a gas stream 12 at the top of the extract stripping section T3. According to one or more embodiments, the gas stream 12 is combined with water, such as the water recovered at the top of the water stripping section (not represented). Phase separation in the condenser-settler CD3 makes possible the recycling of the hydrocarbon phase to the liquid-liquid extractor T1 as raffinate recycle stream 15 and the aqueous phase 14 is optionally combined with the aqueous scrubbing liquor 18 and sent to the water stripping section (not represented). The purified extract 13 is subsequently sent to the aromatic recovery tower T6 in order to separate the aromatics from the solvent (in particular from sulfolane), which is recycled to the liquid-liquid extractor T1.

The stripping of the extract 11 is preferably carried out at low pressure or even under vacuum in order to improve the removal of the non-aromatics from the solvent (in particular from sulfolane). According to one or more embodiments, the extract stripping section T3 is operated at a top pressure of between 0.001 and 2 MPaa (0.01 and 20 bara), preferably between 0.005 and 1 MPaa (0.05 and 10 bara), preferably between 0.01 and 0.8 MPaa (0.1 and 8 bara), preferably between 0.03 and 0.5 MPaa (0.3 and 5 bara), such as 0.14±0.06 MPaa, for example when the solvent comprises sulfolane. According to one or more embodiments, the extract stripping section T3 is operated at a bottom temperature of between 50 and 300° C., preferably between 100 and 250° C., preferably between 130 and 200° C., preferably between 145 and 195° C., such as 180±5° C., for example when the solvent comprises sulfolane.

### Water Stripping Section (Optional—not Represented)

The stripping of the aqueous scrubbing liquor 18 and of the aqueous phase 14 makes it possible to remove the dissolved hydrocarbons (mainly non aromatic) from the water resulting from the top of the extract stripping section T3 and optionally from the water scrubbing tower T2.

According to one or more embodiments, at least a part of the water obtained at the outlet of the water stripping section is sent into the aromatic recovery tower T6 in order to increase the amount of stripping steam sent into the bottom of the aromatic recovery tower T6.

### Aromatic Recovery Tower T6

The aromatic recovery tower T6 separates the purified extract 13 resulting from the bottom of the extract stripping section T3 into an aromatic stream 17 and the solvent stream 9. Preferably, the aromatic recovery tower T6 operates under vacuum, in particular when the solvent comprises sulfolane. Advantageously, the operation under vacuum makes it possible to avoid an excessive bottom temperature, which might result in the decomposition of the solvent. According to one or more embodiments, steam 8, optionally combined with solvent (regenerated), is injected into the bottom of the aromatic recovery tower T6, in order to improve the extraction of the aromatics from the solvent (in particular from sulfolane). The top vapours from the tower (comprising essentially aromatic compounds and optionally water) are condensed and optionally separated by settling in a condenser-settler CD6. According to one or more embodiments, a part of the condensed top aromatic vapours is used for the reflux of the aromatic recovery tower T6 and the remainder, constituting the aromatic stream 17, exits from the process and is preferably sent to an aromatics complex (unit for the separation and production of aromatic compounds and in particular of BTX compounds). A part of the water 16 separated by settling in the condenser-settler CD6 can optionally be sent to the water scrubbing tower T2 and the remainder is recycled to the water stripping section. The stream resulting from the bottom of the aromatic recovery tower T6 is composed of regenerated solvent sent to the liquid-liquid extractor T1, and optionally to the extract stripping section T3 and/or to the solvent regeneration section (not represented).

According to one or more embodiments, the aromatic recovery tower T6 is operated at a top pressure of between 0.001 and 2 MPaa (0.01 and 20 bara), preferably between 0.005 and 1 MPaa (0.05 and 10 bara), preferably between 0.01 and 0.5 MPaa (0.1 and 5 bara), preferably between 0.015 and 0.2 MPaa (0.15 and 2 bara), such as 0.06±0.04 MPaa, for example when the solvent comprises sulfolane. According to one or more embodiments, the aromatic recovery tower T6 is operated at a bottom temperature of between 50 and 300° C., preferably between 100 and 250° C., preferably between 120 and 200° C., preferably between 130 and 195° C., such as 170±25° C., for example when the solvent comprises sulfolane.

Advantageously, the aromatic stream 17 comprises at least 95% by weight, preferably at least 99% by weight, very preferably at least 99.5% by weight (e.g., at least 99.5% by weight), of aromatic compounds, with respect to the total weight of the aromatic stream 17.

### EXAMPLES

An example of process according to the invention for the separation of the aromatics originating from a gasoline cut resulting from catalytic cracking technologies is as follows.

The characteristics of the FCC gasoline treated by the process according to the invention are presented in Table 1.

TABLE 1

| | | Gasoline |
|---|---|---|
| Content | Unit | feedstock 1 |
| Sulfur | ppm by | 70.6 |
| | weight S | |
| Paraffins | % by weight | 15.93 |
| Olefins | % by weight | 34.49 |
| Diolefins | % by weight | 0.92 |
| Naphthenes | % by weight | 4.72 |
| Aromatics | % by weight | 43.94 |
| including C6-C7 aromatics | % by weight | 14.70 |
| including C8-C9 aromatics | % by weight | 23.19 |
| including C10 aromatics | % by weight | 5.61 |
| including C11+ aromatics | % by weight | 0.44 |

The gasoline feedstock 1 is treated in the selective hydrogenation unit A in the presence of a catalyst A1. The selective hydrogenation catalyst A1 is a catalyst of the type of NiMo on γ-alumina. The metal contents in the catalyst are respectively 7% by weight NiO and 11% by weight MoO₃ with respect to the total weight of the catalyst, i.e. an Ni/Mo molar ratio of 1.2. The gasoline feedstock 1 is brought into contact with hydrogen 2 in a reactor which contains the catalyst A1. This stage of the process carries out the selective hydrogenation of the diolefins and the conversion (increase in molecular weight) of a part of the light mercaptan compounds (RSH) present in the feedstock.

The operating conditions employed in the selective hydrogenation reactor are:
temperature:
total pressure: 2.5 MPaa
H₂/feedstock ratio by volume: 5 standard m³ of hydrogen per m³ of gasoline at standard conditions (vol/vol)
liquid hourly space velocity (LHSV):

The selective hydrogenation effluent 3 having a low content of diolefins and a low content of light sulfur compounds (increased in molecular weight in the selective hydrogenation stage) is sent into the fractionation unit B in order to separate the C5− cut 4 at the top of the first fractionation column B1 and the C6+ cut 5 at the bottom of said column. The characteristics of the C5− cut 4 and of the C6+ cut 5 are shown in Table 2. As shown in Table 2, the C5− cut 4 has a low sulfur content. The C5− cut 4 corresponds to approximately 25% by weight of the selective hydrogenation effluent 3. The C6+ cut 5 corresponds to approximately 75% by weight of the selective hydrogenation effluent 3. The C6+ cut 5 has a naphthalene content of 0.4% by weight.

TABLE 2

| | | C5− | C6+ |
|---|---|---|---|
| Content | Unit | Cut (4) | Cut (5) |
| Sulfur | ppm by | | 93.3 |
| | weight S | | |
| Paraffins | % by weight | 28.7 | 12.6 |
| Olefins | % by weight | 70.1 | 22.9 |
| Diolefins | % by weight | 0.58 | 0.16 |
| Naphthenes | % by weight | 0.61 | 6.18 |
| Aromatics | % by weight | 0.01 | 58.16 |
| including C6-C7 aromatics | % by weight | 0.01 | 19.42 |
| including C8-C9 aromatics | % by weight | | 30.73 |
| including C10 aromatics | % by weight | | 7.43 |
| including C11+ aromatics | % by weight | | 0.58 |
| including 217° C.+ | % by weight | | 0.43 |

The C6+ cut 5 is treated in the hydrogenation unit C in the presence of a first hydrogenation catalyst C1 of NiMo type making possible the hydrogenation of the olefins and of a second hydrotreating catalyst C2 of the type of CoMo on an alumina support making possible the removal of the sulfur, nitrogen and oxygen compounds.

In the hydrogenation unit C, the C6+ cut 5 is brought into contact with hydrogen in a reactor which contains the catalysts C1 and C2. This stage of the process carries out in particular the hydrogenation of the olefins and of the alkenylaromatic compounds and also the conversion of the sulfur and mercaptan compounds present in the feedstock, and limits the hydrogenation of the aromatics.

The operating conditions employed in the hydrogenation and hydrotreating reactor are:
temperature:
total pressure: 2.6 MPaa
H₂/feedstock ratio by volume: 150 standard m³ of hydrogen/m³ of feedstock at standard conditions
liquid hourly space velocity (LHSV):

In this example, the effluent exiting from the hydrogenation reactor is sent into a fractionation column of the hydrogenation unit C, in order to remove the H₂S and the light gases, such as ethane, propane and butane.

The characteristics of the hydrogenation effluent 6 at the outlet of the hydrogenation unit C are shown in Table 3.

TABLE 3

| | | Hydrogenation |
|---|---|---|
| Content | Unit | effluent 6 |
| Paraffins | % by weight | 32.3 |
| Olefins | % by weight | 0.0 |
| Naphthenes | % by weight | 10.8 |
| Aromatics | % by weight | 56.9 |
| including C6-C7 aromatics | % by weight | 19.1 |
| including C8-C9 aromatics | % by weight | 30.0 |
| including C10 aromatics | % by weight | 7.22 |
| including C11+ aromatics | % by weight | 0.58 |
| including 217° C.+ | % by weight | 0.42 |

The hydrogenation effluent 6 subsequently feeds the liquid-liquid extractor T1 of the aromatic extraction unit D. A solvent stream 9 comprising 99.4% by weight of sulfolane is added at the top and a raffinate recycle stream 15 is added at the bottom of the liquid-liquid extractor T1. A [solvent stream 9]/[hydrogenation effluent 6] ratio by weight of 5 and a [raffinate recycle stream 15]/[hydrogenation effluent 6] ratio by weight of 0.9 are involved at the liquid-liquid extractor T1, which is operated at a pressure between 0.5 and 0.8 MPaa and at a temperature of 54° C.

The raffinate 10 is extracted at the top of the liquid-liquid extractor T1 and then sent to the optional water scrubbing tower T2 in order to remove the small amount of sulfolane solvent which is entrained in the raffinate 10. The aqueous scrubbing liquor 18 is composed essentially of water and sulfolane, and the non-aromatic stream 19 is composed of the raffinate devoid of solvent.

For the sake of simplicity, the optional water stripping and solvent regeneration sections are not represented in FIG. 3. Said optional water stripping and solvent regeneration sections make it possible to treat the water streams used in the process according to the invention and to purify the sulfolane.

The extract 11 from the liquid-liquid extractor T1 feeds the extract stripping section T3, which makes it possible to remove the non-aromatics entrained with the solvent and the aromatics and to create the raffinate recycle stream 15 returning to the liquid-liquid extractor T1.

Beforehand, the gas stream 12 at the top of the extract stripping section T3 is sent to the condenser-settler CD3 in order to remove the aqueous phase 14.

The extract stripping section T3 comprises a stripping column operated at a bottom temperature of 180° C.

The purified extract 13 at the bottom of the extract stripping section T3, containing essentially the solvent and aromatics, is sent to the aromatic recovery tower T6, which makes it possible to recover, at the bottom, the solvent recycled to the liquid-liquid extractor T1 as solvent stream 9 and to recover a top stream which is sent to the condenser-settler CD6, which makes it possible to withdraw a water 16 separated by settling and an aromatic stream 17. The aromatic recovery tower T6 operates by sending steam 8 into the column bottom.

The aromatic recovery tower T6 is operated at a bottom temperature of 180° C.

The compositions by weight of the exiting streams of the aromatic extraction unit D are presented in Table 4.

TABLE 4

| | | Non-aromatic | Aromatic |
|---|---|---|---|
| Content | Unit | stream 19 | stream 17 |
| Paraffins | % by | 62.9 | 0.0 |
| | weight | | |
| Olefins | % by | 0.0 | 0.0 |
| | weight | | |
| Naphthenes | % by | 21.1 | 0.0 |
| | weight | | |
| Aromatics | % by | 16.0 | 100.0 |
| | weight | | |
| including C6-C7 aromatics | % by | 0.1 | 39.9 |
| | weight | | |
| including C8-C9 aromatics | % by | 7.2 | 53.6 |
| | weight | | |
| including C10 aromatics | % by | 7.9 | 6.4 |
| | weight | | |
| including C11+ aromatics | % by | 0.8 | 0.1 |
| | weight | | |

The distribution by weight of the streams of the process at entering and leaving the overall sequence is presented in Table 5.

TABLE 5

| | Distribution of the feedstock |
|---|---|
| Stream | (fraction by weight) |
| Gasoline feedstock 1 | |
| C5− Cut 4 | 0.25 |
| Hydrogenation effluent 6 | 0.75 |
| Non-aromatic stream 19 | 0.39 |
| Aromatic stream 17 | 0.36 |

1. Process for the treatment and separation of aromatic compounds starting from a gasoline feedstock, comprising the following stages:
selective hydrogenation (A) of the gasoline feedstock (1) in order to hydrogenate at least diolefins contained in the gasoline feedstock (1) in the presence of hydrogen (2) and to produce a selective hydrogenation effluent (3);
fractionation (B) of the selective hydrogenation effluent (3) in order to produce at least a C5-cut (4) containing compounds having 5 or less carbon atoms and a C6+ cut (5) containing compounds having at least 6 carbon atoms;
hydrogenation (C) of the C6+ cut (5) in order to hydrogenate at least olefins contained in the C6+ cut (5) in the presence of hydrogen and to produce a hydrogenation effluent (6);
extraction of the aromatics (D) from the hydrogenation effluent (6) in order to produce at least an aromatic stream (17) concentrated in aromatic compounds with respect to the hydrogenation effluent (6) and a raffinate (10) concentrated in non-aromatic compounds with respect to the composition of the hydrogenation effluent (6).

2. Process according to claim 1, in which the gasoline feedstock (1) comprises a gasoline cut resulting from a catalytic cracking unit.

3. Process according to claim 1, in which the selective hydrogenation stage (A) is carried out at at least one of the following operating conditions: presence of at least one catalyst comprising a support and an active phase comprising at least one element from Group VIII, temperature of between 50 and 250° C., liquid hourly space velocity LHSV of between 0.5 h⁻¹ and 20 h⁻¹, pressure of between 0.4 and 5 MPa, H₂/gasoline feedstock ratio by volume of between 2 and 100 Sm³/m³.

4. Process according to claim 1, in which the fractionation stage (B) is controlled in order to produce a C6+ cut (5) exhibiting a content of less than or equal to 5000 ppm by weight of compounds having a boiling point of greater than 217° C.

5. Process according to claim 1, in which the hydrogenation stage (C) is carried out at at least one of the following operating conditions: presence of at least one catalyst comprising a support and an active phase comprising at least one element from Group VIII, temperature of between 100 and 400° C., liquid hourly space velocity LHSV of between 0.1 h⁻¹ and 20 h⁻¹, pressure of between 0.1 and 5 MPaa, H₂/gasoline feedstock ratio by volume of between 1 and 400 Sm³/m³.

6. Process according to claim 1, in which the stage of extraction of the aromatics (D) comprises the following stages:
extraction of the aromatics from the hydrogenation effluent (6) by means of a liquid-liquid extractor (T1) fed with a solvent stream (9) in order to separate the raffinate (10) and an extract (11) concentrated in aromatics with respect to the composition of hydrogenation effluent (6);
stripping of the extract (11) by means of an extract stripping section (T3) in order to separate a gas stream (12) comprising non-aromatic compounds and a purified extract (13);
separation of the aromatics from the purified extract (13) and the solvent by means of an aromatic recovery tower (T6) in order to separate the solvent stream (9) and top vapours comprising the aromatic stream (17).

7. Process according to claim 6, in which the stage of extraction of the aromatics (D) additionally comprises at least one of the following stages:
feeding the liquid-liquid extractor (T1) with a solvent stream (9) comprising a solvent chosen from the list consisting of ethylene glycol, diethylene glycol, triethylene glycol, hexamethylphosphoramide, propylene carbonate, ethylene carbonate, sulfolane, 3-methylsulfolane, N-methylacetamide, N,N-dimethylacetamide, butyrolactone, 1-methylpyrrolidone, dimethyl sulfoxide, caprolactam, N-methylformamide, pyrrolidin-2-one, furfural, 1,1,3,3-tetramethylurea and a mixture of these;
phase separation of the gas stream (12) in a condenser-settler (CD3) in order to separate a raffinate recycle stream (15) and an aqueous phase (14);
scrubbing the raffinate (10) with water by means of a water scrubbing tower (T2) fed with water (7) in order to produce a non-aromatic stream (19) and aqueous scrubbing liquor (18);
regeneration of at least a portion of the solvent stream (9) by means of a section for regeneration of the solvent by vacuum steam stripping;
condensation of the top vapours in a condenser-settler (CD6) in order to produce the aromatic stream (17).

8. Process according to claim 7, in which the solvent stream (9) comprises sulfolane.

9. Process according to claim 7, in which the stage of extraction of the aromatics (D) additionally comprises at least one of the following stages:
feeding the liquid-liquid extractor (T1) with a stream of solvent chosen from ethylene glycol, diethylene glycol, triethylene glycol, hexamethylphosphoramide, propylene carbonate, ethylene carbonate, sulfolane, 3-methylsulfolane, N-methylacetamide, N,N-dimethylacetamide, butyrolactone, 1-methylpyrrolidone, dimethyl sulfoxide, caprolactam, N-methylformamide, pyrrolidin-2-one, furfural, 1,1,3,3-tetramethylurea and a mixture of these;
recycling the raffinate recycle stream (15) to the liquid-liquid extractor (T1);
stripping the hydrocarbon compounds present in the aqueous scrubbing liquor (18) and/or in the aqueous phase (14) by means of a water stripping section in order to produce water;
feeding the aromatic recovery tower (T6) with steam (8) in order to produce top vapours additionally comprising steam, and condensation of the top vapours in the condenser-settler (CD6) in order to produce the aromatic stream (17) and water (16) separated by settling.

10. Process according to claim 9, in which the stage of extraction of the aromatics (D) additionally comprises at least one of the following stages:
feeding the liquid-liquid extractor (T1) with a solvent stream (9) comprising sulfolane and water;
recycling the water produced by the water stripping section to the aromatic recovery tower (T6).

11. Device for the treatment and separation of aromatic compounds starting from a gasoline feedstock, comprising the following units:
a selective hydrogenation unit (A) for hydrogenating at least diolefins contained in the gasoline feedstock (1) in the presence of hydrogen (2) and for producing a selective hydrogenation effluent (3);
a fractionation unit (B) for fractionating the selective hydrogenation effluent (3) and producing at least a C5− cut (4) containing compounds having 5 or less carbon atoms and a C6+ cut (5) containing compounds having at least 6 carbon atoms;
a hydrogenation unit (C) for hydrogenating at least olefins contained in the C6+ cut (5) in the presence of hydrogen and producing a hydrogenation effluent (6);
an aromatic extraction unit (D) for extracting aromatics from the hydrogenation effluent (6) and producing at least an aromatic stream (17) concentrated in aromatic compounds with respect to the hydrogenation effluent (6) and a raffinate (10) concentrated in non-aromatic compounds with respect to the composition of the hydrogenation effluent (6).

12. Device according to claim 11, in which the aromatic extraction unit (D) comprises the following elements:
a liquid-liquid extractor (T1) suitable for being fed with a solvent stream (9) and the hydrogenation effluent (6) and suitable for separating the raffinate (10) and an extract (11) concentrated in aromatics with respect to the composition of the hydrogenation effluent (6);
an extract stripping section (T3) suitable for being fed with the extract (11) and suitable for separating a gas stream (12) comprising non-aromatic compounds and a purified extract (13); and
a recovery tower (T6) suitable for being fed with the purified extract (13) and suitable for separating aromatics from the purified extract (13) in order to produce the solvent stream (9) and top vapours comprising the aromatic stream (17).

13. Device according to claim 12, in which the aromatic extraction unit (D) additionally comprises at least one of the following elements:
a liquid-liquid extractor (T1) suitable for being fed with a solvent stream (9) comprising a solvent chosen from the list consisting of ethylene glycol, diethylene glycol, triethylene glycol, hexamethylphosphoramide, propylene carbonate, ethylene carbonate, sulfolane, 3-methylsulfolane, N-methylacetamide, N,N-dimethylacetamide, butyrolactone, 1-methylpyrrolidone, dimethyl sulfoxide, caprolactam, N-methylformamide, pyrrolidin-2-one, furfural, 1,1,3,3-tetramethylurea and a mixture of these;
a condenser-settler (CD3) suitable for being fed with the gas stream (12) and suitable for separating the gas stream (12) and producing a raffinate recycle stream (15) and an aqueous phase (14);
a water scrubbing tower (T2) suitable for being fed with water (7) and the raffinate (10) and suitable for scrubbing the raffinate (10) with water and producing a non-aromatic stream (19) and aqueous scrubbing liquor (18);
a solvent regeneration section suitable for being fed with at least a portion of the solvent stream (9) and suitable for regenerating the portion of the solvent stream (9) by vacuum steam stripping;
a condenser-settler (CD6) suitable for being fed with the top vapours and suitable for condensing the top vapours and producing the aromatic stream (17).

14. Device according to claim 13, in which the aromatic extraction unit (D) additionally comprises at least one of the following elements:
a liquid-liquid extractor (T1) suitable for being fed with a solvent stream (9) comprising a solvent chosen from the list consisting of ethylene glycol, diethylene glycol, triethylene glycol, hexamethylphosphoramide, propylene carbonate, ethylene carbonate, sulfolane, 3-methylsulfolane, N-methylacetamide, N,N-dimethylacetamide, butyrolactone, 1-methylpyrrolidone, dimethyl sulfoxide, caprolactam, N-methylformamide, pyrrolidin-2-one, furfural, 1,1,3,3-tetramethylurea and a mixture of these;
a liquid-liquid extractor (T1) suitable for being fed with the raffinate recycle stream (15);
a water stripping section suitable for being fed with the aqueous scrubbing liquor (18) and/or the aqueous phase (14) and suitable for stripping the hydrocarbon compounds from the aqueous scrubbing liquor (18) and/or from the aqueous phase (14) in order to produce water;
an aromatic recovery tower (T6) suitable for being fed with steam (8) and suitable for producing top vapours additionally comprising steam, and a condenser-settler (CD6) suitable for condensing the top vapours in order to produce the aromatic stream (17) and water (16) separated by settling.

15. Device according to claim 14, in which the aromatic extraction unit (D) additionally comprises at least one of the following elements:
a liquid-liquid extractor (T1) suitable for being fed with a solvent stream (9) comprising sulfolane and water;
an aromatic recovery tower (T6) suitable for being fed with the water produced by the water stripping section.
